(19) United States
(12) Patent Application Publication
(10) Pub. No.: US 2004/0136688 A1
(43) Pub. Date: Jul. 15, 2004

(54) Video processing system

(76) Inventor: Anthony David Searby, Newbury (GB)

Correspondence Address: Mark G Lappin, McDermott Will & Emery, 28 State Street, Boston, MA, 02109, US

(21) Appl. No.: 10/451,561

(22) PCT Filed: Dec. 20, 2001
(86) PCT No.: PCT/GB01/05605

(30) Foreign Application Priority Data
Dec. 21, 2000 (GB) 0031403.9

(51) Int. Cl. H04N 5/76; G11B 27/00

(52) U.S. Cl. 386/52; 386/64

(57) ABSTRACT

A video processing system (55) is designed to output edited clips in different video output formats, in which an edited clip is produced by applying a video effect to source clips in at least first and second different formats during an editing process. The system includes an image processor (60) for rendering to produce new video content for a video effect based on the video content of source clips in first and second different formats. The image processor (60) is operable to generate the new video content in a plurality of video output formats. There is also provided a store (70) comprising a plurality of storage locations (13, 14, 16) each for holding a version of the new video content in each of the plurality of video output formats. A controller (10) is provided for controlling the output of an edited clip including the new video content in a video output format selected from the plurality of video output formats, wherein the controller (10) outputs a version of the new video content from a storage location (13, 14, 16) holding the version in the selected video output format.

### FIELD OF THE INVENTION

The invention relates to video processing systems and particularly to video processing systems capable of outputting video images in two or more different formats.

Video processing systems are used in a variety of fields to edit or modify video prior to outputting a resultant clip. The term “clip” as used herein refers to a series of frames which are continuous in time and arranged to be played rapidly and consecutively in sequence. Video effects applied to video clips to alter the appearance of video footage include dissolves, fades, wipes, colour transformations, overlays and other well known examples.

Such effects usually involve one or more source clips and require the creation of new (or “intermediate”) frames to generate a resultant clip. The resultant clip comprises video content from each of the source clips and the new frames. The exact composition and number of new frames is dependent on the precise nature of the video effect employed.

### BACKGROUND ART

A video clip can exist in any one of a number of different formats. Examples of different formats include standard definition TV, high definition TV of various sizes, RGB, YUV, 8-bit, 10-bit, 12-bit, logarithmic, for example, compressed in various forms including JPEG and MPEG. Known video editing systems can output video clips in different video formats. However, known video editing systems suffer image quality problems in playing out clips which include the types of video effects mentioned above. Known video editing systems store newly generated intermediate frames associated with video effects in a single format. The intermediate frames are usually rendered to the highest resolution format at which they will be played out and stored in this format until they are required. The intermediate frames are played out without converting between formats when the output employs the high resolution format in which they are stored. Where a different format is selected for playing out, the intermediate frames are converted to the desired format and output. Problems in the visual quality of output clips, arise in particular where intermediate frames have been transformed through too many conversions prior to being output.

The present invention seeks to provide an improved video processing system.

### SUMMARY OF INVENTION

According to an aspect of the present invention, there is provided a method of video processing to facilitate output of edited clips in different video output formats, wherein an edited clip is produced by applying a video effect to source clips in at least first and second different formats during an editing process, the method comprising: rendering to produce new video content for a video effect based on the video content of source clips in different formats, including producing the new video content in a plurality of video output formats; storing a version of the new video content in each of said plurality of video output formats; and outputting the edited clip including the new video content in a video output format selected from the plurality of video output formats, wherein the step of outputting the edited clip comprises outputting the version of the new video content stored in the selected video output format.

According to another aspect of the present invention, there is provided a video processing system for outputting edited clips in different video output formats, wherein an edited clip is produced by applying a video effect to source clips in first and second different formats during an editing process; the system comprising: an image processor for rendering to produce new video content for a video effect based on the video content of source clips in first and second different formats, wherein the image processor is operable to generate the new video content in a plurality of video output formats; a store comprising a plurality of storage locations, one for holding a version of said new video content in each of said plurality of video output formats; and a controller to control the output of an edited clip including the new video content in a video output format selected from the plurality of video output formats, wherein the controller outputs a version of the new video content from a storage location holding the version in the selected video output format.

According to another aspect of the present invention, there is provided a method of video editing to facilitate output of edited video clips in a plurality of different formats, comprising: receiving source clips in first and second video formats; rendering using frames from each of the source clips to generate new frames for an effect applied to the source clips to produce a resultant clip during an editing process, wherein the rendering process provides the new frames in a plurality of different video output formats; storing a plurality of versions of said new frames in a store, each said version being in a different one of said plurality of video output formats; and selecting from said plurality of video formats a video format for outputting the resultant clip including the new frames, wherein the version of the new frames in the selected output format is output from the store without undergoing any type of conversion between formats.

Thus, preferred embodiments can overcome problems with known video editing systems by rendering newly created intermediate frames of video effects into each of the different formats used for outputting the video. Multiple versions of the intermediate frames are stored in the various formats in which they are likely to be output. Having versions of the intermediate frames stored in a plurality of different output formats eliminates the need to convert them from the format in which they are stored into the format in which they are to be output, thereby improving image quality during play out of a clip containing the intermediate frames.

The present invention also provides for an image processing system comprising a data store which is capable of storing input signals from a plurality of different sources in a format which obtains on reception, an image processor capable of processing the stored input signals in different formats, and a format converter which serves selectively to convert, a stored signal to a desired output signal format.

A format converter may be provided in parallel with a straight through path to feed the processor from the store, which format converter operates to convert the format of data passed therethrough to the same format as data routed via the straight path. Advantageously, the conversion direction is chosen always to go from the format considered to have the least resolution to the format considered to have the higher or highest resolution.

Additional objects, advantages and novel features of the invention are set forth in part in the description which follows, and in part will become apparent to those skilled in the art upon examination of the following text and accompanying drawings.

An embodiment of the invention will now be described, by way of example only, with reference to the accompanying drawing in which:

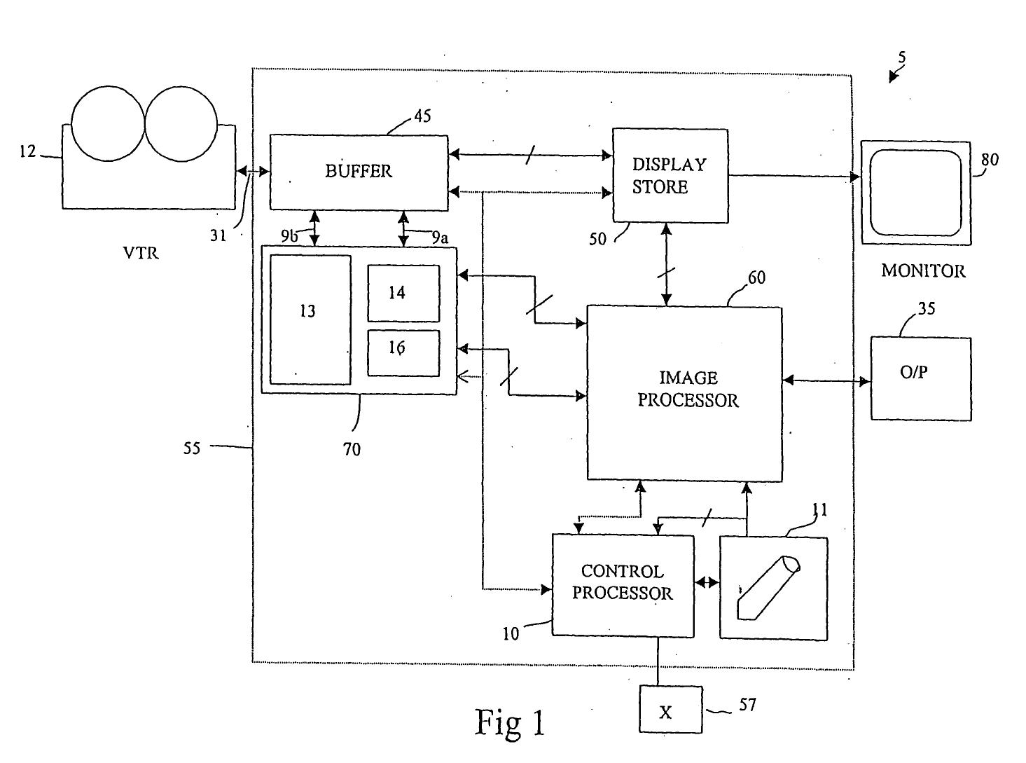

FIG. 1 is a schematic block diagram of a video processing system which embodies the invention;

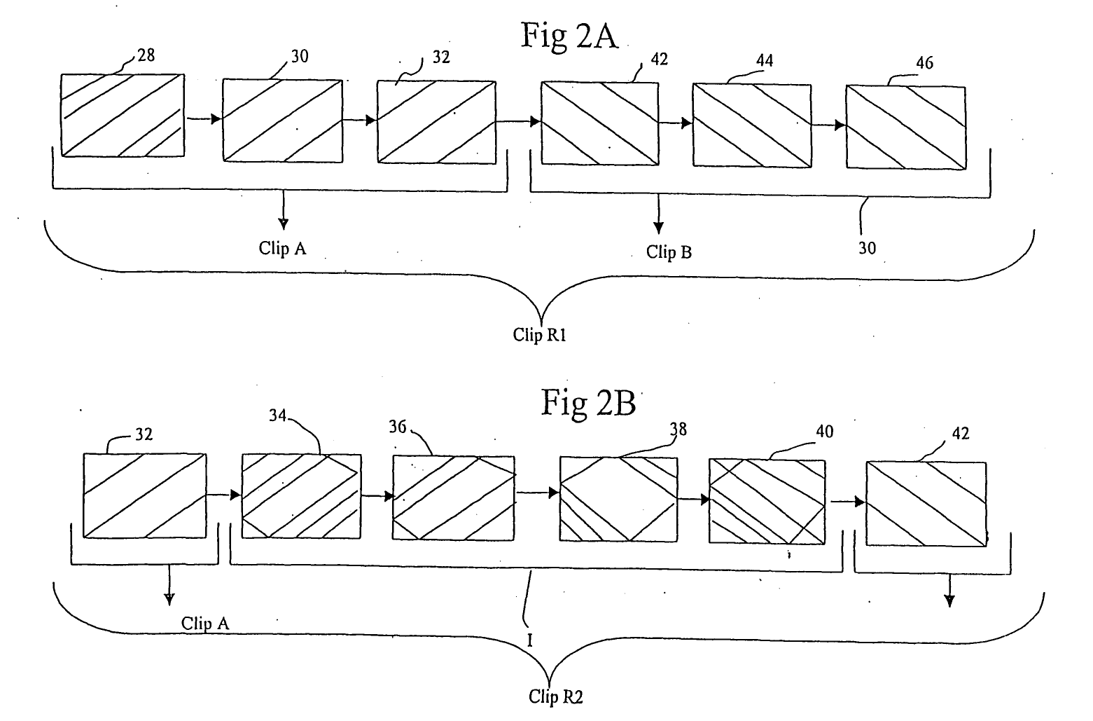

FIG. 2a is a time line showing two consecutive clips;

FIG. 2b is a time line showing two consecutive clips linked by a series of intermediate frames;

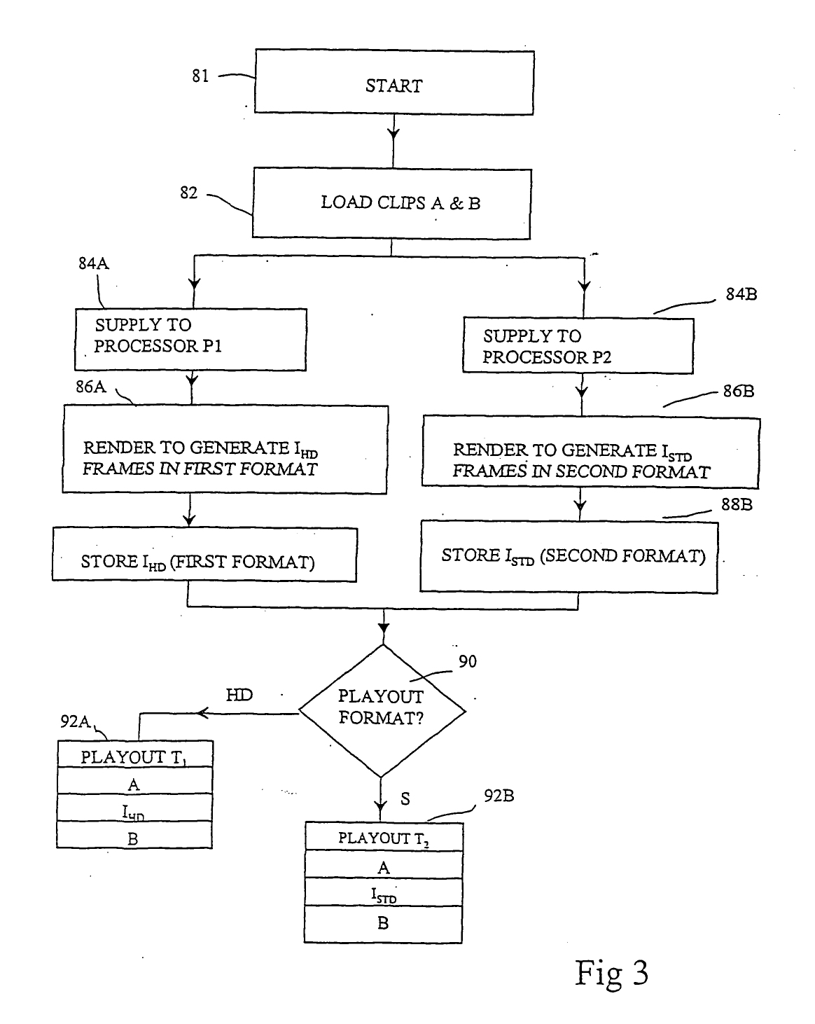

FIG. 3 shows the creation of intermediate frames in a method embodying the invention.

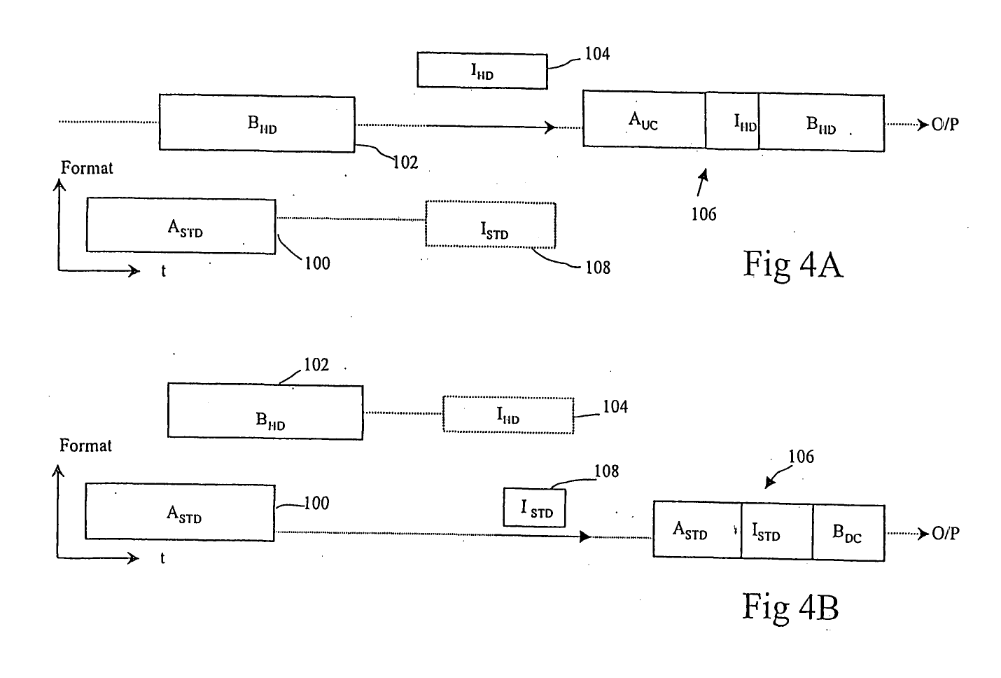

FIG. 4A illustrates play out of a first sequence of clips; and

FIG. 4B illustrates play out of a second sequence of clips.

FIG. 1 shows a video processing system 5 comprising a video tape recorder (VTR) 12, a video editing system 55, a monitor 80 and a video output port 35. In practice, the video output port 35 might be connected to a broadcast station or another type of communications node.

The video tape recorder (VTR) 12 is used to transfer video clips between a video tape and the video editing system 55. The Video tape facility provides a bulk off-line library of video clips and the VTR 12 provides a means by which archived video clips can be retrieved from the library for use as source video clips in the editing system 55. The term “source clip” is used herein to refer to a video clip which has been read from an external device into the video editing system 55. The source clip may never have been edited or it may have been edited or otherwise processed using different equipment at some time in the past. The VTR 12 also provides a means by which a resultant video clip created in the editing system 55 can be archived onto video tape for later use either in the same or a different system. The VTR 12 may be connected to, or indeed replaced by, other external sources such as a video camera or even a computer for generating video data representing 3-D animation or other computer-related effects.

The editing system 55 comprises a buffer 45, a display store 50, an image processor 60, a video disk store 70, a control processor 10, and a user interface 11. The buffer 45 is connected to the VTR 12 via a video data path 31. The buffer 45 provides an interface between the VTR 12 and the display store 50, the processor 60 and the video disk store 70. The buffer 45 is used to transfer incoming video clip data from the VTR 12 via bidirectional buses 9a, 9b to the video disc store 70 and at the same time to transfer the incoming data to the display store 50 for display on the monitor 80. Hence, a video clip from the VTR 12 can be previewed on the monitor 80 by the user while it is being loaded into the video disk store 70.

The display store 50 is designed for storing data relating to several (typically many) frames of video. The image processor 60 processes the frame data therein to produce respective frames for display at different portions of the monitor 60. The image processor 60 presents video clips on the monitor 80 in a plurality of different ways to enable editing functions to be performed by the user of the system. A video clip may be read out from the video store 70 and written directly to the display store 50 or, alternatively, video clips may be transferred directly from the bulk storage of the VTR 12 via the buffer 45 to the display store 50.

The video disk store 70 comprises multiple disk storage units (not shown separately) arranged to receive and transmit clip data to/from the two bi-directional data paths 9a and 9b, each capable of conveying video clips at video rate. The video disk store 70 is therefore able to store many minutes of video for processing by the editing system 55 and to output and/or receive simultaneously at least two video clips at a video rate for editing and other modifications. Various storage locations 13,14,16 of the disk store 70 hold source clips and new (“intermediate”) frames generated to create video effects. Source clips input via the buffer 45 are usually held in the disk store 70 in the format in which they are input. Intermediate frames rendered to generate video effects are stored in all formats in which they could be output. In this embodiment, separate versions of these intermediate frames are stored, one in a high definition TV format and another in a standard definition TV format. It is envisaged that the system could be expanded to store intermediate clips or frames in a plurality of different formats, at the choice of the designer, including, for example, standard definition TV, high definition TV of various sizes, RGB, YUV, 8-bit, 10-bit, 12-bit, logarithmic, for example, compressed in various forms including JPEG and MPEG. The modifications required to the embodiment described will be readily apparent to the skilled person.

The control processor 10 of the video editing system 55 communicates between the user interface 11 and the remainder of the editing system 55. The control processor 10 is connected to the buffer 45, the display store 50, the image processor 60, and the video disc store 70. The control processor 10 controls the modifications and implements processing applied to the video clip data by the image processor 60. Control paths from the control processor 10 are shown as broken lines in FIG. 1. During editing the control processor 10 controls the transfer of video clip data from the buffer 45 to the display store 50 such that several frames from each clip are caused to be displayed simultaneously or in sequence at different or overlapping or shared portions of the monitor 80. The control processor 10 also controls the image processor 60.

A mode selector switch 57 is connected to the control processor and may be used to select between single or plural output format modes. In a single output-format mode intermediate frames are only generated and stored in one format. The format may be selected from a drop-down menu on the monitor 80. In plural output format mode, the editing system generates and stores intermediate frames in a plurality of different predetermined formats. The formats can be selected from a number of menu options displayed on monitor 80.

The image processor 60 performs operations necessary to generate the desired effects on selected frames in the video clips. For example, processor operations include the generation of keying signal, modification of colour, changing of texture, or spatial effects such as changes of size, position and/or spin. This supports video effects such as dissolves, fades, wipes, colour transformations, and overlays and the processing operations required to produce them are well known.

The image processor 60 is, in this embodiment, provided with two separate data paths each served by an independent processor P1, P2 (depicted in FIG. 3). This arrangement enables, for example, parallel (concurrent) processing of two sets of source clip data to generate a result clip. In another embodiment, only a single processor path is provided in the image processor, while in other embodiments more than two processor paths are provided.

The selection and modification of video clips and frames within the clips is controlled by the user who causes the desired manipulation by means of the user interface 11. In this embodiment, the user interface 11 is a stylus and touch table device which can be used to select any one of a number of source clips and predefined functions presented in a menu on the monitor 80. The results of an edit can be viewed immediately. The image processor 60 is also connected to the video output port 35 so that any edited clips can be output in real time.

Video output port 35 enables the resultant clips to be output to the desired destination in whatever format is appropriate. In practice video output port 35 may comprise one or a plurality of physical output ports.

FIGS. 2A and 2B illustrate, by way of example, how two source clips are processed to generate new frames of a video effect for inclusion in a resultant edited clip. The first resultant clip R1, shown in FIG. 2A, consists of first and second source clips A and B. Only three frames of each source clip are shown for clarity, namely frames 28,30,32 of clip A and frames 42,44,46 of clip B. The frames making up the source clips A,B are played directly one following the other to produce the resultant clip R1. This resultant clip represents a simple edit combining the first and second clips A,B such that they are played out consecutively in the desired sequence. No special video effects are used to achieve the transition between the clips A and B in the resultant clip R1.

FIG. 2B shows a resultant clip R2 including the source clips A and B and additionally a series of intermediate frames I. The intermediate frames I are newly generated frames which are rendered by the image processor 60 using known techniques to achieve a video effect in the resultant edited clip. For example, the intermediate frames I may be new frames required to a achieve a wipe effect from the first clip A to the second clip B. In such a case, the content of the intermediate frames I represents a progression from the content of the last frame 32 in the first clip A to the content of the first frame 42 in the second clip B.

In this simplified example, the content of the first intermediate frame 34 might consist of substantially the same content as the last frame 32 of clip A with only a small amount of content of the first frame 42 of clip B. Conversely, the content of the last intermediate frame 40 might consist of substantially the same content as the first frame 42 of clip B with only a small amount of content from the last frame 32 of clip A. The plurality of intermediate frames appearing therebetween, of which only two 36,38 are shown, provide a gradual progression of content from frame 34 to frame 40. A different variation in content might apply with other video effects. The resultant clip R2 (not all of which is shown) thus consists of the frames 28,30,32 of clip A, the intermediate frames 34,36,38,40 and the frames 42,44,46 of clip B played in that order.

FIG. 3 illustrates steps in the creation of intermediate frames and the output of resultant edited clips in selected predetermined formats. The user at the user interface 11 causes the control processor 10 to start the process, as indicated by reference numeral 81. At step 82, the control processor 10 causes the disk store 70 to load the clips A and B. This step may have been performed in advance.

Referring to the left hand portion of FIG. 3, clip data required to render the intermediate frames for the desired video effect is supplied to the first processor P1 of the image processor 60 in step 84A. The clip data is used by the first processor in step 86A to render intermediate frames in a first format, in this example according to the known high definition video standard. In step 88A the version I_{HD} of the intermediate frames generated by the rendering process of the first processor P1 is stored in a first storage location 14 of the disk store 70 in a high definition format.

Referring to the right hand portion of FIG. 3, clip data required to render a further version of the intermediate frames for the desired effect is supplied to the second processor P2 of the image processor 60 in step 84B. The clip data is used by the second processor in step 86B to render intermediate frames I_{STD} in a second format, in this example according to the known standard definition video standard. In step 88B, the version of the intermediate frames I_{STD} generated by the rendering process of the second processor is stored in a second location 16 of the disk store 70 in a standard definition format.

Thus, in operation the image processor 60 processes source clips from the store, on two independent data paths, rendering the contents of clips to generate new (“intermediate”) frames required to achieve any one of a number of predetermined types of video effect. The processor 60 also converts video between different formats as necessary to provide a resultant clip in the desired output format, as will be explained below.

At step 90 the system determines the format in which the resultant clip is to be output from a plurality of possible output formats. If the first format (high definition) has been selected as the output format, then the high definition version of the intermediate frames I_{HD} is played out directly from the first storage location 14. That is, a resultant clip which is played out comprises clip A, the intermediate frames I_{HD}, and clip B in that sequence. (See step 92A). One or more of clips A and B can be converted from their natural formats into high definition in real time if necessary. Such conversion can be of standard type. However, a possible method of handling clips A and B can be that described below and in particular in British patent application 0031403.9.

If, on the other hand, the second format (standard definition) has been selected as the output format, then the standard definition version of the intermediate frames I_{STD} is played out directly from the second storage location 16. In other words, a resultant edited clip comprising clip A, the intermediate frames I_{STD}, and clip B in that order are played out in sequence (See step 92b). One or more of clips A and B can be converted from their natural formats into standard definition in real time if necessary.

FIGS. 4A and 4B illustrate examples of outputting resultant edited clips in more detail. Referring to FIG. 4A, the source clip A 100 is stored in standard definition format, whereas the source clip B 102 is stored in high definition format. Where, as in this case, high definition is selected as the format for outputting the resultant clips, the high definition version I_{HD} 104 of the intermediate frames is used. That is, the resultant edited clip 106 comprises clip A_{UC}, I_{HD}, and clip B_{HD} in that order. The subscript “UC” indicates that clip A must be up-converted from standard definition format to high definition format to be played out as part of the resultant high definition clip 106. Clip B is played out in its natural format (high definition).

The content of a clip to be output can therefore be transferred from the video disk store 70 in sequence and played out in the desired output format under the control of the control processor 10. The image processor 60 converts source clips held in the disk store 70 into the format selected for the output clip. Intermediate frames making up content of the output clip are transferred directly from the appropriate one of the stores 14,16 in the selected output format. Thus intermediate frames do not need to be converted between formats before or while being output.

The example in FIG. 4B uses the same source clips, A and B. In this example, standard definition is selected as the format for outputting the resultant clip, the standard definition version I_{STD} 108 of the intermediate frames is used. In other words, the resultant clip 106 comprises clip A_{STD}, I_{STD}, and clip B_{DC} in that order. The subscript “DC” indicates that clip B must be down-converted from high definition format to standard definition format to be played out as part of the resultant standard definition clip 106. Clip A can be played out in its natural format (standard definition).

It will be apparent that the standard definition version of the intermediate frames I_{STD} is in effect redundant when the resultant clip is played out in high definition, and vice versa.

Thus either of the two different versions (in this embodiment) of the intermediate frames I_{HD}, I_{STD} in high definition and standard definition formats respectively can be selectively output with the remainder of the clips and without having to undergo format conversion. Avoiding format conversion of these intermediate frames improves picture quality when video effects are used. Further, where it is known that only one output format will be required the mode control switch 57 on the editing system can be used to ensure that only one version of the intermediate frames is generated and stored by the system. This saves processing time and disk space where output will not be in different formats.

Software driven drop-down menus can be used to indicate which format (or formats) it will be required to output and therefore in which format (or formats) the intermediate frames are stored.

As Mentioned above, British patent application no. 0031403.9 discloses a method of storing and editing video input signals which can be used for storing and processing source clips for which no intermediate frames are required or which may otherwise be desired for later retrieval. Using this method, input signals (source clips)—in various input formats are fed to an input signal selector under control of a user control interface so that the source clips can be stored in their input format together with their format information. The format information can typically be in the form of a label attached to the data stored.

For these source clips which are not converted to intermediate frames, the control processor decides whether the source clip required format conversion. If conversion is required, this is carried out, otherwise the source slip is fed directly to the output without conversion. Output data from the processor is similarly fed to an output via a ‘straight through’ path or via an output format converter, only if necessary.

Thus it will be appreciated, that in cases where no format change is required, data is fed directly to the output from the data store via a ‘straight through’ path. If a format change is required then this is carried out, preferably using the most suitable processing format which will cause the least degradation. Similarly after processing is complete, further format conversion is applied only as necessary to provide a predetermined output format, which may thereafter be output from the system or returned to the store (if required).

For such format conversion, it is preferred that the conversion direction is chosen always to go from the format considered to have the least resolution to the format considered to have the higher resolution.

The drawings depict one exemplary embodiment of the invention. The specific apparatus configuration and methods steps disclosed herein are not intended to be limiting. A skilled person will readily appreciate that modifications to the disclosed embodiment as well as other embodiments provide equally feasible alternative means for performing the invention.

A skilled person will appreciate a number of different apparatus configurations can be used, not all of which are intended to be indicated herein. The disclosed embodiment is capable of receiving and processing video on two processor paths. Some embodiments may comprise three or more video data paths and be capable of rendering three or more versions of video data simultaneously, in parallel. Conversely, other embodiments may perform the required method steps in series on a single video data path.

The VTR 12 could alternatively, or in addition, comprise any other form of device capable of inputting video clips. These include video cameras or computers capable of generating video data. Whilst only one inputting source is shown a plurality of sources of the same or different types could be present.

The video disk store 70 is depicted as storing clips and intermediate frames of different definitions in three separate locations (13, 14 and 16). Any number of storage locations may be provided and these may be within a single storage device or distributed over a plurality of individual storage devices.

As depicted in FIG. 1 the control processor 20 only has command over the video disc store 70, image processor 60, the buffer 45 and display store 50. The control processor 10 could also be linked to the monitor 80, and video output 35 to control other aspects of the video processing system. Also the control processor 10 is indicated to be linked to a user interface 11 to enable a human operator to direct the video data system. This process could instead be automated with the user interface being replaced by any device suitable to allow a computer or machine to manipulate the video processing system.

Further apparatus features could be added to provide additional functions. These could include, for example, editing stores to record details of changes made to clips and/or audio stores. Features comprised in one unit in FIG. 1 could also be split into multiple units. An example would be to have separate units perform the image processing and format conversion functions carried out by the image processor 60 of FIG. 1. A further example would be to include separate video and audio data stores for storing clips of different formats.

FIG. 2 represents an effect where only two clips are blended to produce the intermediate frames. Other techniques involving blending one or three or more clips would also constitute embodiments of the invention. FIG. 3 shows a process whereby clips are used which initially occur in two different formats. The invention would apply equally to clips which occurred initially in three or more formats.

Although this embodiment discloses a system using standard and high definition TV formats, a plurality of different formats may be employed. These different formats may or may not include standard and high definition TV formats and may number greater than two. Examples of other video formats include RGB, YUV, 8-bit, 10-bit, 12-bit, logarithmic, for example, compressed in various forms including JPEG and MPEG. Of course, embodiments of the invention may be used with video standards not yet adopted or known or with other types of standards for use in applications other than TV/video.

Elements/components which are described herein in terms of apparatus could alternatively be provided in software and vice-versa. For example, the mode switch 57 could be provided in software.

1. A method of video processing to facilitate output of edited clips in different video output formats, wherein an edited clip is produced by applying a video effect to source clips in at least first and second different formats during an editing process, the method comprising:
rendering to produce new video content for a video effect based on the video content of source clips in different formats, including producing the new video content in a plurality of video output formats;
storing a version of the new video content in each of said plurality of video output formats; and
outputting the edited clip including the new video content in a video output format selected from the plurality of video output formats, wherein the step of outputting the edited clip comprises outputting the version of the new video content stored in the selected video output format.

2. A method as in claim 1, wherein the selected video output format is one of said first and second video formats.

3. A method as in claim 1 or 2, wherein the step of outputting the edited clip comprises outputting video content of a source clip in the selected video output format.

4. A method as in claim 1, 2 or 3, wherein the step of outputting the edited clip comprises outputting video content of a source clip which has been converted from one of said first and second formats into the selected video output format.

5. A method as in any preceding claim, wherein the plurality of video output formats includes a third video format different to either of the first and second video formats.

6. A method as in claim 5, wherein the selected video output format comprises the third video format.

7. A method as in claim 6, wherein the step of outputting the edited clip comprises converting video content of a source clip from one of said first and second video formats into said third video format.

8. A method as in any preceding claim, wherein the steps of rendering to generate new video content in each of the plurality of video output formats are performed substantially contemporaneously.

9. A method as in any one of claims 1 to 7, wherein the steps of rendering to generate new video content in each of the plurality of video output formats are performed consecutively in time.

10. A method as in any preceding claim, wherein a format is selected from one or more of the following: standard definition TV, high definition TV of various sizes, RGB, YUV, 8-bit, 10-bit, 12-bit, logarithmic, uncompressed or compressed in various forms including JPEG and MPEG.

11. A method according to any preceding claim, wherein the video effect is selected from one or more of the following: dissolves, fades, wipes, colour transformations, overlays.

12. A method according to any preceding claim, including the steps of storing source clips not to be edited in the format in which they are received and selectively converting said source clips into a selected output format during a data output operation.

13. A method according to claim 12, wherein said conversion is chosen to go from the format considered to have the least resolution to the format considered to have a higher resolution.

14. A computer program product comprising program code means adapted to perform the method of any preceding claim.

15. A video processing system for outputting edited clips in different video output formats, wherein an edited clip is produced by applying a video effect to source clips in first and second different formats during an editing process; the system comprising:
an image processor for rendering to produce new video content for a video effect based on the video content of source clips in first and second different formats, wherein the image processor is operable to generate the new video content in a plurality of video output formats;
a store comprising a plurality of storage locations, one for holding a version of said new video content in each of said plurality of video output formats; and
a controller to control the output of an edited clip including the new vide content in a video output format selected from the plurality of video output formats, wherein the controller outputs a version of the new video content from a storage location holding the version in the selected video output format.

16. Apparatus as in claim 15, comprising selector means to select a mode of operation in which only a single version of the new video content is generated.

17. Apparatus as in claim 15, comprising selected means to provide a selection of video output formats from which the or each desired video output format can be selected.

18. A method of video editing to facilitate output of edited video clips in a plurality of different formats, comprising:
receiving source clips in first and second video formats;
rendering using frames from each of the source clips to generate new frames for an effect applied to the source clips to produce a resultant clip during an editing process, wherein the rendering process provides the new frames in a plurality of different video output formats;
storing a plurality of versions of said new frames in a store, each said version being in a different one of said plurality of video output formats; and
selecting from said plurality of video formats a video format for outputting the resultant clip including the new frames, wherein the version of the new frames in the selected output format is output from the store without undergoing any type of conversion between formats.
